(19) United States
(12) Patent Application Publication
(10) Pub. No.: US 2011/0320318 A1
(43) Pub. Date: Dec. 29, 2011

(54) CONTEXT-AWARE SHOPPING SERVICES ON MOBILE

(76) Inventors: Amol Bhasker Patel, Los Altos, CA (US); Suraj Satheesan Menon, San Jose, CA (US)

(21) Appl. No.: 13/154,048

(22) Filed: Jun. 6, 2011

Related U.S. Application Data
(60) Provisional application No. 61/359,221, filed on Jun. 28, 2010.

(51) Int. Cl. G06Q 30/00

(52) U.S. Cl. 705/26.62

(57) ABSTRACT

A user is alerted on their mobile devices when a desired or potentially desirable item is available for purchase. The user can provide information about what the user is interested in purchasing, such as a general item (e.g., a 32″ LCD television), a specific item (e.g., a white Apple iPad2), a maximum price the user is willing to pay for the item, distance from user, availability (e.g., in stock, available within two weeks, not yet available but will be, etc.). A service provider may run queries to obtain information from merchants and other sellers. When there is a match with the user-specified parameters, the user is sent a notification, such as by SMS, email, voice message, or WAP Push, of the match.

### CROSS REFERENCE TO RELATED APPLICATIONS

The present application claims priority to common-owned U.S. Provisional Patent Application Ser. No. 61/359,221, filed Jun. 28, 2010, incorporated by reference in its entirety

### BACKGROUND

1. Field of the Invention

The present invention generally relates to shopping using mobile devices, and more particularly, to receiving alerts on the mobile device based on user preferences

2. Related Art

Online shopping has been increasing and continues to increase, based in part on the ease of finding items for purchase, making the payment, and receiving the purchased items. Thus, the user can conveniently shop from the comfort of the user's home or office. One limitation to this type of commerce is that the user typically needs to be in front of their home or office computer. As society becomes more and more mobile, opportunities for online shopping may be reduced.

To address the needs of the mobile society, mobile devices, such as smart phones and computing tablets, are being used more as computing devices, in addition to phone or communication functions. One feature of some mobile devices is the ability to shop and pay through the user's mobile device. One difficulty in making purchases through a mobile device is not being aware of when a desired or potentially desired item is nearby or available. Other difficulties with mobile device shopping include a small screen and keyboard, making it hard for the user to search for items using the device, and the limitation of typically being able to run only one application at a time on the device.

Thus, a need exits to allow a user to shop and buy through the user's mobile device without the disadvantages of conventional methods described above.

### SUMMARY

In one embodiment, users are alerted on their mobile devices when a desired or potentially desirable item is available for purchase. The user can provide information about what the user is interested in purchasing, such as a general item (e.g., a 32″ LCD television), a specific item (e.g., a white Apple iPad2), a maximum price the user is willing to pay for the item, distance from user, availability (e.g., in stock, available within two weeks, not yet available but will be, etc.). A service provider may run queries to obtain information from merchants and other sellers. When there is a match with the user-specified parameters, the user is sent a notification, such as by SMS, email, voice message, or WAP Push, of the match. The user can then go the physical location where the item is located, make a purchase on the mobile device, or other action. The user may also make the purchase through the mobile device first and then pick up the purchase or make the purchase through the mobile device and have the purchase shipped to the user.

The user, once notified, may initiate a communication with the seller or merchant, such as through text, chat, email, call, or other means. This enables the user to get real time information from the seller, as well as possibly reaching an agreement for a purchase.

In another embodiment, a web service or app may be available to merchants or sellers for identifying items available for purchase to the user when one or more items of the merchant meets a user search criteria. For example, in addition to the notification of a matching item, other offerings of the merchant may also be displayed to the user on the user's mobile device.

Therefore, the user can be notified of items specifically desired by the user at any user location and at any time, even when the user is using the mobile device, such as on a call, using an app, etc. This then allows quick and easy purchase through the mobile device for a context-aware shopping experience on the mobile device.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flow chart showing a process between a user and a service provider for a context aware shopping experience according to one embodiment;

FIG. 2 is a flow chart showing a process for a user to set up a context aware service;

FIG. 3 is a flow chart showing a process for a service provider to run a query for the user;

FIG. 4 is a diagram showing a networked system configured to facilitate a context aware service embodiment of the invention; and

FIG. 5 is a block diagram of a computer system suitable for implementing one or more devices in FIG. 4 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In one embodiment, a service provider, such as PayPal, provides users the capability to run a service (in the background) based on user-preferences, such that the user gets an alert of items that are on the user's watch-list. The user can continue using other mobile applications, but whenever a trigger event occurs, the user will get a notification. The medium of this notification is user defined, so that it can be an SMS that the user gets, or an instruction to the merchant to contact the opted-in interested buyer, or integrated with the user's map application providing location of the item that can be purchased. Merchants are integrated with the service provider backend so the purchase transaction can happen from the buyer's mobile device itself. This information/alert service can be aggregated across platforms (e.g., online merchants, mobile merchants, classifieds, etc). This is also very useful in international emerging markets where assisted m-commerce through location information can result in increased productivity gains due to weak physical infrastructure.

In one embodiment, the user first provides preferences to the service provider. For example, the user may launch an application for the service on the mobile device, where the application may be provided through the service or payment provider, or access the service provider site through a personal computer or other computing device.

Preferences may be parameters on which the user wants notification. Examples include a general description of the goods or services of interest, such as a television, a specific type of product, which may include a description and/or a model number and manufacturer, a maximum price the user is willing to pay, how far the user is willing to go for the product (which can be from the user's home location or the location where the device is at any given time), etc. The user may list any number of products or services of interest.

If the preferences are set from the user's mobile device, e.g., through an application on the device, the user can quit the application after the preferences are entered and the service will continue to run in the background. In other words, the user can use or access other functions or applications on the device and still be notified when the service finds something of interest based on the user's preferences.

The service provider may continually to query its server or other database to determine whether any merchants have offerings that match the preferences of the user. Merchants may continually update offerings with the service provider, which would include where a particular item is located and can be purchased from, the price, any coupons or discounts available, the number of items available, store hours, free shipping, etc. Note that the “store” or where the item is purchased does not have to be at a physical POS or location, but can be on-line through an Internet merchant or other seller.

In one embodiment, the user is notified any time an item of interest is found by the service. In another embodiment, the user is notified when the user accesses the service on the user's device, where a list of all items would be displayed. The service provider may search continually, at periodic intervals, when the user updates a preference, when a merchant updates an offering, and/or when the user launches the service. The search may include merchants, retailers, individual sellers, classified ads, market places, and any other sales avenue from which the service provider can obtain information from.

If location-based, i.e., the user has set preferences based on location, the results are generated from the location where the user specified. For example, if the user set a distance of 10 miles from the mobile device, the results may be based on the mobile device location at the time the service provider performs the search. If the user sets a distance based on the user's home or business address, the results may be based on that location.

The application running in the background may be implemented in various ways, depending on the platform. For example, in an iPhone OS 3.0 from Apple, if apps cannot be currently executed in the background, the service provider may push notification to notify the user. However, in the iPhone OS 4.0, the service can run in the background. Similar functionality is available in Android and RIM.

Users can be notified in many ways, which may be based on a user preference, the user device, and/or the service provider. Examples include notification by SMS, WAP Push, email, voice message, or the like. The notification may also be from the merchant. Once notified, the user may purchase the item on the mobile device, such as through the service provider or other means. The user and/or merchant may initiate communication with the other, such as through a chat, text, email, etc. such that the two parties may communicate in real-time and obtain real-time information regarding a possible transaction or purchase. The user may also notify the merchant to hold the item or simply go to the location to finish the transaction, such as payment and pick-up. The notification may also include integration with a map function on the user's device. For example, the merchant location may be shown on a map, which the user can use to navigate to the location.

Where location is not important, the user may set preferences for certain items, vacations, flights, services, etc. for notification when a certain price is reached. This way, the user does not have to regularly search, but is simply notified when the service provider finds something meeting the user's preferences. The user may then make the purchase on the mobile device, on a PC, or other means.

In one embodiment, when or after the user is notified that there is match on a search query, the user is presented with a “cart” or other type of listing showing available items and/or services from a merchant or seller. This can be viewed directly on the user device or accessed through a link or other means. The cart may include the desired item(s), as well as other items or services offered by the merchant or seller.

As a result, such a context-aware shopping service provides users with an easier way to find and purchase desired items.

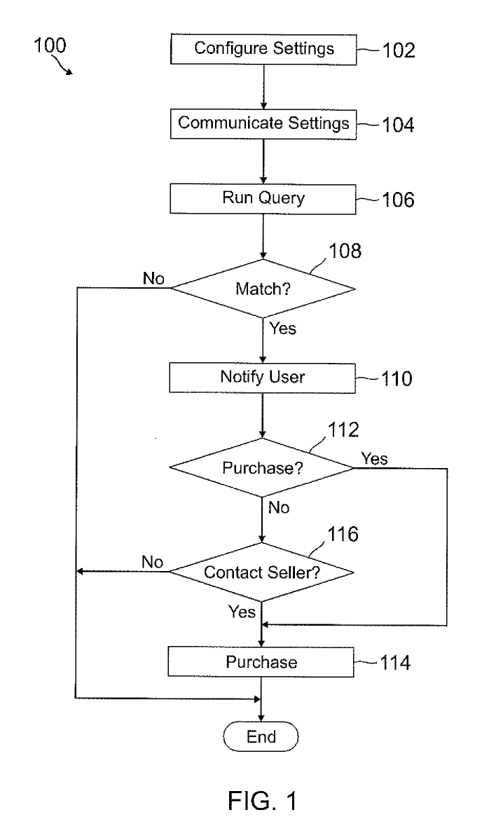

FIG. 1 is a flow chart showing a process 100 between a user and a service provider for a context aware shopping experience according to one embodiment. At step 102, the user configures settings or parameters for a search. The user may specify one or more general items (note that item will be used herein generally to include products, digital goods, services, and anything else that can be purchased) and/or one or more specific items. Parameters may also include price information, such as a maximum price, a minimum price, or a range, and item availability information (e.g., available now at a physical location, available now by shipping, available by a certain date, not yet available but will be available, etc.).

The user may also specify location of the item and whether shipping is desired, and if so, whether shipping will be included in the price. The location may be based on the location of the user (e.g., the location of the mobile device), a “home” or “office” location, or other location. The location can be specific, such as within five miles of the location base, or general, such as in California or outside the United States. If a specified address, the user may input a specific address, city, or other location/region. If based on the location of the user, the user may allow the service provider to obtain location information of the user device through device location based services.

Other parameters the user may set include one or more specific merchants, merchants/sellers with a minimum rating, condition of item (e.g., new, refurbished, used, etc.), and the like. The user may also define a time period of interest for the item. For example, the user may only be interested in a specific item for a trip or meeting and would therefore need to have the item before the trip or meeting.

Once provided, the user parameters are communicated to the service provider at step 104. Communication may depend on how the user provides the parameters. For example, if the user provides the information through a service provider website, the information may be communicated by the user confirming the parameters. If the user provides the information through an app of the service provider on the user's device, the information may be communicated by a call to the service provider. The above may involve the user entering information into fields or boxes such that the service provider receives the information in the desired format for processing. The user may also use voice, email, or other communications means where the user conveys the parameters in any general format. In such a case, the service provider enters the parameters, either manually or electronically.

Next, at step 106, the service provider runs queries or searches for the user based on the information received. The service provider may search or query its database or another database, such as a merchant's or a third party's, for any items that match item settings or parameters. The service provider may also poll one or more merchants requesting whether a merchant has an item matching the user parameters. The search or query may be run periodically, such as set by the user or the merchant, or triggered by an event, such as a merchant revising an inventory or price of offered items. The search is run through the service provider, so that the search is completely transparent to the user.

After results from a search are returned or processed, a determination is made, at step 108, whether there are any matching items. A match may not be from an exact match, but one that is close. For example, the user and/or the service provider may consider a match a result that only differs from a small amount or where the difference is not in an important parameter. For the former, a result may return an item and merchant in which the price is 5% over the maximum set by the user. For the latter, a result may return an item and merchant in which the item is located at a distance 5% greater than the maximum set by the user. This allows the user to consider and possibly purchase an item that would still be acceptable, but not strictly within the user's parameters. In addition, the user may be able to communicate with the seller to revise some of the parameters, such as reducing the price.

If there is a match, the user is notified at step 110. Notification can be through any means. Examples include notification through the user mobile device by text (SMS), email, voice message, or a push notification. The user may also be notified through a user computing device, such as a PC, or at the user's home/office (through a call, mail, or fax). Notification can be sent when a matching result is received by the service provider or a time interval after, such as five minutes. Alternatively, the user may be notified at periodic intervals, either set by the user or the service provider. The user may be notified by the service provider, by the merchant with the matching offer, and/or by a third party service.

Once notified, the user can decide whether to purchase the found item(s) at step 112. If the user decides to purchase the item, the user may make the purchase at step 114. For example, the user may select a link to make the purchase through the user's mobile device, such as through the service provider or a payment provider. The user may then pick up the purchased item or have the item shipped. Alternatively, the user may go to the location where the item is located and make the purchase at a point of sale of the seller. The purchase may again be through the user's mobile device or conventionally, such as with check, cash, or credit. The user may then pick up the item immediately.

However, even when a matching item is found, the user may decide to not purchase, as determined at step 112. Reasons include the matching item is at the high range of the price parameter, the matching item is not “perfect” and the user is not in a hurry to purchase (so the user can afford to wait for a better match), conditions changed for the user, the item is located at an outer limit of the user's location, the merchant offering the item is not highly desired by the user, etc. If the user decides to not make the purchase, the user may also decide whether it is worthwhile to contact the seller or merchant at step 116.

One reason for contacting the seller is when the user would make the purchase if one or more conditions of the merchant offering could be changed. If the price or other terms appear to be negotiable, the user may want to contact the seller. For example, if the item is located at distance that closes soon, the user may want to ask the seller to extend the location closing time. If the item is only offered for the day, but the user cannot make the purchase that day, the user may ask the seller to honor the price and terms the next day. The user may also want to arrange a different delivery option. These and other reasons may all cause the user to want to contact the seller first before declining a purchase.

If that the case, the user contacts the seller, such as using contact information provided in the notification. The user may contact the seller in any suitable manner, such as by a phone call, email, text, or an in-person visit. Assuming the user and seller come to an agreement or the user decides to the make purchase from the original notification, the user makes the purchase at step 114.

As a result, the user is notified and can make a purchase when user set parameters are met or are almost met. The user may be notified when an item is available near the user, and the user can go directly to the item location for pick up and purchase. Thus, a context aware shopping experience is provided to the user, resulting in a smarter way for the user to make a purchase with the use of the user's mobile device. The result benefits all parties, e.g., the user is able to buy a desired item without having to continually search for the item, the seller is able to make a sale, and the payment provider may be able to facilitate the sale.

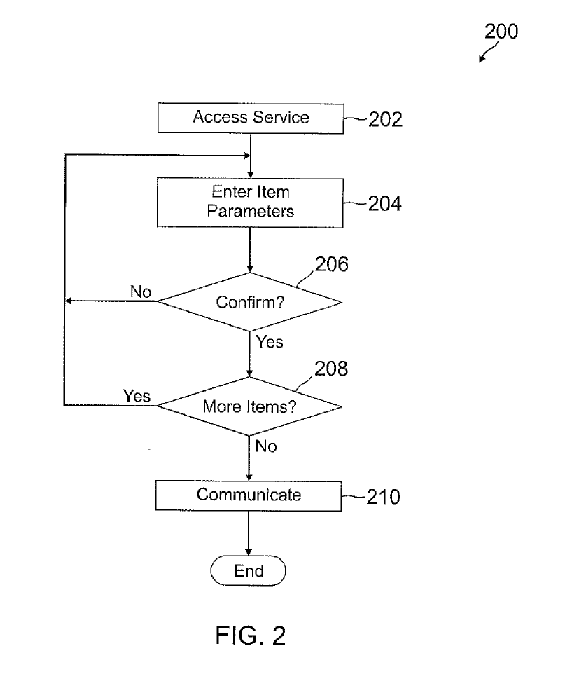

FIG. 2 is a flow chart showing a process 200 a user performs for setting up a context aware service with the service provider according to one embodiment. At step 202, the user accesses the service. This may include first accessing the service provider site (such as through a URL) or app (such as by selecting the desired app on the user mobile device). Once accessed, the user may need to enter credentials to access the user's account, such as an identifier (e.g., phone number, user name, email address) and password or PIN. The user may then select the context aware service offered by the service provider. This can be through selecting a link or tab on the user's home page or directly selecting the appropriate app on the user's mobile device.

Next, at step 204, the user enters search parameters for a desired item. The user may be presented with a form or boxes/fields to fill out. The user may also enter parameters in a free-form such as with a written description. With the latter, the service provider would need to extract the needed data from the description, such as by a human or a software program. Search parameters may range from the very general to the very specific. For example, the user may provide an item description, a price or range, location of the item, specific merchants, excluded merchants, date range, availability, a ranking of importance for the various search parameters, payment methods accepted, specific shipping or delivery options, frequency of search, time for results to be communicated to the user (e.g., immediately after at least one match is received by the service provider or at certain times of the day), etc.

Search parameters for the item may only be one or two terms (such as a 32″ HD television) to any number of terms, with the higher the number of terms, the more specific the search for the item, which may result in a lower number of returned results. However, more specific searches may yield better matches to what the user wants. Thus, the user may adjust the number and specifics of search terms as needed for each desired item.

In one embodiment, the user specifies a location of the item relative to a user location. The user location can be a fixed location set by the user, such as the user's home address, business address, or other address, such as a relative's address, a hotel, etc. For example, if the user is on vacation and needs a certain item, the user can enter the address of where the user is staying, such as a hotel. The user can then pick up a locally available item. In another example, the user may be looking for a large item for a friend or relative. In that case, the user may select the home or office address of the friend or relative, so that the intended party can more easily pick up the item.

The user may also use the location of the user's mobile device, such that the user location is dynamic. This option allows the service provider to use the location service on the user's mobile device to determine the user's location when making a search or running a query. As a result, the user can be notified of any matching item near wherever the user may be at the time, assuming the notification is real-time and not delayed, such that the user may have moved since the search was run and the results returned.

Once the location is set (either a fixed address/position or location of user device), the user may also specify an acceptable distance between the specified location and the item location. For example, the user may set a five mile maximum distance of the item from the specified location. Other ways to enter distance may also be suitable.

After item search terms or parameters are entered, the user determines whether to confirm the search at step 206. The user may be able to review the entered information or search terms to see if all the information is correct. If not, the user can revise or reenter specific information at step 204.

If the information is correct, the user determines, at step 208, whether to add more items for the search. If so, the user enters search parameters for the next item at step 204. The process continues until the user has no more items to enter.

At that point, the user communicates the user's search parameters, at step 210, to the service provider. In one embodiment, the user selects a link or button on a service provider web page or app to transmit the information. If the transmission is successful, the user then just waits for search results to arrive. Note that the search parameters for all the items need not be transmitted or communicated at the same time, but can be sequential, such as after each item's parameters have been entered and/or confirmed. The search terms may also be revised or modified at any time by the user.

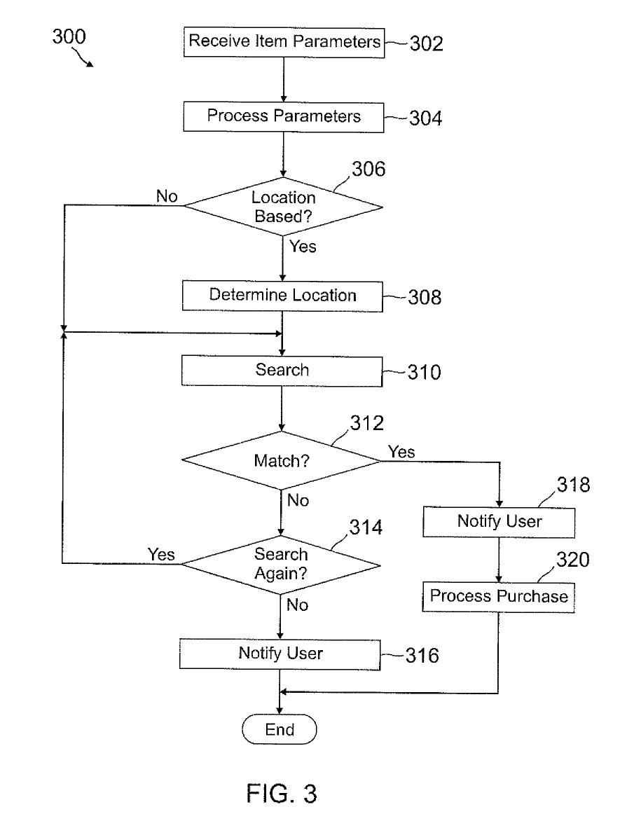

FIG. 3 is a flow chart showing a process 300 a service provider performs for providing the context aware service to the user according to one embodiment. At step 302, the service provider receives one or more search parameters for one or more items. The service provider can be a payment provider, such as PayPal, Inc. of San Jose, Calif. As discussed above, the user enters desired search parameters, which are communicated to and received by the service provider, such as through an app or website. The search parameters are associated with a particular user and user account, such that the service provider may communicate back to the appropriate user the results of a search. Thus, in some embodiments, the user is required to have an account with the service provider to use this service. If the user does not have an account, the user may be requested to sign up for or activate an account, such as known in the art.

After receiving search parameters, the service provider processes the received information at step 304. This may include extracting relevant or appropriate data from the received information. The service provider may also analyze the received search parameters to ensure they are proper and/or complete. For example, the received information may not have included an item description, an incomplete item description, or contradictory item description. The received information may also be so broad that too many results matching the description would be returned. In such situations, the service provider may request the user modify or change certain parameters.

Included in the process is a determination, at step 306, whether the search is location-based. This may simply entail determining whether the user requested a location-based search and provided necessary information for such a search. If the search will be location-based, as determined at step 306, the service provider determines location information at step 308. The user may have set a specific location, such as by address, city, building, coordinates, or other means. In this case, the service provider extracts the location information and converts, if necessary, that information to a format that it uses for a search. If the search will be based on the location of the user device, the service provider determines the present location of the user device right before performing the search. Present location can be obtained from location-based services on the user device.

A search is then performed at step 310. The service provider may continually to query its server or other database to determine whether any merchants have offerings that match the preferences of the user. Merchants or sellers may continually update offerings with the service provider, which would include where a particular item is located and can be purchased from, the price, any coupons or discounts available, the number of items available, store hours, free shipping, availability through in-store pick up only or online purchase and shipping only, etc. The search frequency may depend on a user set preference or be determined by the service provider. For example, the search may be performed continuously, every hour, every day, any time a merchant updates inventory, etc.

At step 312, a determination is made whether there are any matches from the search. A match can be an exact match of all user parameters or a partial match. For a partial match to be considered a match, the service provider may determine how “close” the match was, whether the user indicated a partial match would be acceptable, which parameters did not match exactly (as there may be some parameters not as crucial as others), etc. The user may provide indications of which parameters may be less important, or the service provider may decide that on its own, such as based on information about the product, the user parameters, the user transaction history, etc. In addition, a partial match may be considered a match if the time period for the search is near its end. In that case, the user may want the item even though it does not meet all the user's parameters. Thus, there are advantages of categorizing an offering a match even though not a perfect or exact match. Even if the user may not want the item as offered, the user may be able to communicate with the seller to negotiate terms acceptable to both parties. This is possible because the user is notified of a possible offering, along with seller information, so that the user can then contact the seller immediately and directly.

If a match is found, the user is notified, at step 318. In one embodiment, the user is notified through the user's mobile device by text, a push notification, email, or a voice message. The notification may be through other means, such as a user's PC, a phone call to the user's home or office, a facsimile, etc. The notification may include information such as a description of the found item, the offering merchant, the price, availability (when and how many), location, shipping information, etc., as well as active links, tabs, or buttons that allow the user to obtain more information about the item, contact the seller, make a purchase, or other actions.

The notification, both how delivered and when delivered, may be set by the user, set by the service provider, a combination. In one embodiment, the service provider notifies the user immediately after a matching result is received.

Once notified, the service provider may process the purchase, at step 320, based on user input. As discussed above, the user may want to make the payment through the user's device. As such, the user may select a “Pay” or “Purchase” button/link, which lets the service provider know to initiate a checkout or payment process. The user is then asked to enter specific information, as is known in the art, which the service provider processes to either confirm or deny the payment. The processing may also include notifying the user and/or seller of a confirmed or denied payment. The service provider may also process other parts of the transaction, e.g., if the user wants to have the item shipped instead of picking up the item locally.

Referring back to step 312, if no match is found from a search, the service provider determines whether another search is to be made at step 314. The determination may be based on user or service provider settings. For example, the time limit for the search may have just expired or the number of searches as reached its maximum. If no subsequent search is to be made, the user may be notified at step 316. Beyond just a “no matches found” type of message, notification may include details of what parameters were not met, the closest offerings, and an option to revise any search parameters to begin a new search.

If another search is to be made, searching begins again at step 310. The search can be immediately, after a certain time period, on a triggering event, such as an update to a seller's inventory/offerings, or other time. This can be determined by user preferences and/or service provider rules.

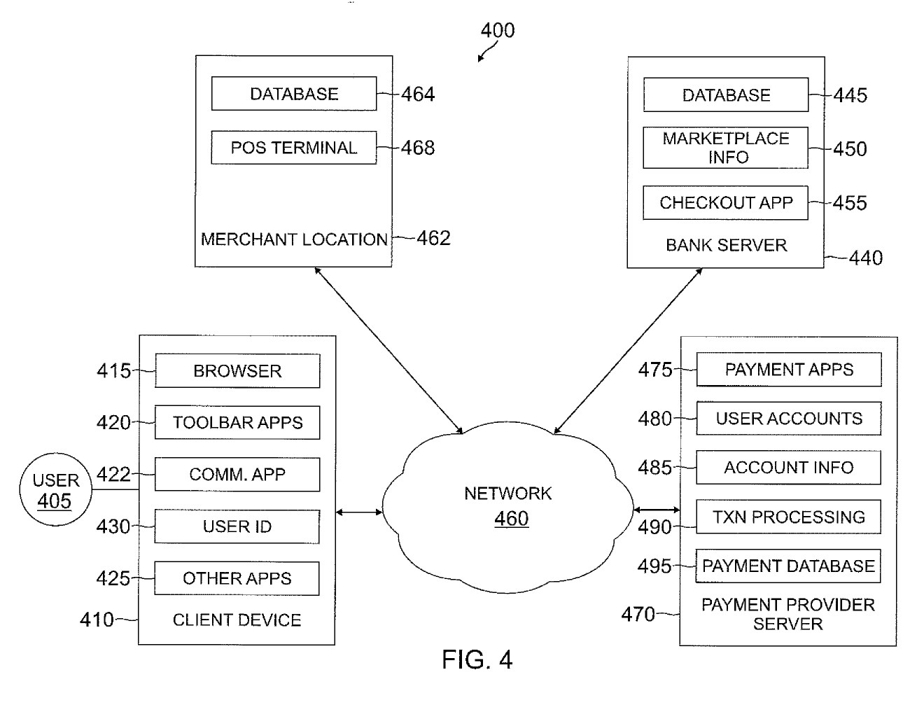

FIG. 4 is a block diagram of a networked system 400 configured to handle a shopping process between a user and one or more merchants/sellers, such as described above, in accordance with an embodiment of the invention. System 400 includes a user device 410, a merchant server 440, a merchant location device 462, and a payment provider server 470 in communication over a network 460. Payment provider server 470 may be maintained by a payment provider, such as PayPal, Inc. of San Jose, Calif. A user 405, such as a consumer, utilizes user device 410 for a shopping experience facilitated by payment provider server 470, with one or more merchants.

User device 410, merchant server 440, merchant location device 462, and payment provider server 470 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

Network 460 may be implemented as a single network or a combination of multiple networks. For example, in various embodiments, network 460 may include the Internet or one or more intranets, landline networks, wireless networks, and/or other appropriate types of networks.

User device 410 may be implemented using any appropriate hardware and software configured for wired and/or wireless communication over network 460. For example, in one embodiment, the user device may be implemented as a personal computer (PC), a smart phone, personal digital assistant (FDA), laptop computer, and/or other types of computing devices capable of transmitting and/or receiving data, such as an iPad™ from Apple™.

User device 410 may include one or more browser applications 415 which may be used, for example, to provide a convenient interface to permit user 405 to browse information available over network 460. For example, in one embodiment, browser application 415 may be implemented as a web browser configured to view information available over the Internet or access a website of the payment provider. User device 410 may also include one or more toolbar applications 420 which may be used, for example, to provide client-side processing for performing desired tasks in response to operations selected by user 405. In one embodiment, toolbar application 420 may display a user interface in connection with browser application 415 as further described herein.

User device 410 may further include other applications 425 as may be desired in particular embodiments to provide desired features to user device 410. For example, other applications 425 may include security applications for implementing client-side security features, programmatic client applications for interfacing with appropriate application programming interfaces (APIs) over network 460, or other types of applications. Applications 425 may also include email, texting, voice and IM applications that allow user 405 to send and receive emails, calls, texts, and other notifications through network 460, as well as applications that enable the user to communicate, place orders, and make payments through the payment provider as discussed above. User device 410 includes one or more user identifiers 430 which may be implemented, for example, as operating system registry entries, cookies associated with browser application 415, identifiers associated with hardware of user device 410, or other appropriate identifiers, such as used for payment/user/device authentication. In one embodiment, user identifier 430 may be used by a payment service provider to associate user 405 with a particular account maintained by the payment provider as further described herein. A communications application 422, with associated interfaces, enables user device 410 to communicate within system 400.

Merchant server 440 may be maintained, for example, by a merchant or seller offering various items, products and/or services in exchange for payment to be received over network 460. Generally, merchant server 440 may be maintained by anyone or any entity that receives money, which includes charities as well as retailers and restaurants. Merchant server 440 includes a database 445 identifying available products and/or services (e.g., collectively referred to as items) which may be made available for viewing and purchase by user 405. Accordingly, merchant server 440 also includes a marketplace application 450 which may be configured to serve information over network 460 to browser 415 of user device 410 and/or payment provider server 470. In one embodiment, user 405 may interact with marketplace application 450 through browser applications over network 460 in order to view various products, food items, or services identified in database 445. Marketplace application 450 may also be used to communicate or transmit details of available offerings to the payment provider for search, as described above.

Merchant server 440 also includes a checkout application 455 which may be configured to facilitate the purchase by user 405 of goods or services identified by marketplace application 450. Checkout application 455 may be configured to accept payment information from or on behalf of user 405 through payment service provider server 470 over network 460. For example, checkout application 455 may receive and process a payment confirmation from payment service provider server 470, as well as transmit transaction information to the payment provider and receive information from the payment provider (e.g., a transaction ID). Checkout application 455 may also be configured to accept one or more different funding sources for payment. Furthermore, checkout application 455 may be used to generate a purchase identifier associated with details of a user purchase, where the user then uses the identifier to pay online for the purchase at a later time.

Merchant location device 462 may be a register, kiosk, terminal, or other device at a physical merchant location, such as where items may be purchased. In one embodiment, merchant location device 462 includes a database 484, which may store information regarding current, past, and future inventory at the location and transaction details associated with purchases at the location. A point of sale (POS) terminal 468 may also be included, which allows the merchant to process a sales or purchase transaction with user 405. For example, POS terminal 468 may communicate with payment provider server 470 to facilitate a payment from user 405 for one or more items at the merchant location or confirm a payment was made by user 405.

Payment provider server 470 may be maintained, for example, by an online payment service provider which may provide payment between user 405 and the operator of merchant server 440 and/or merchant location device 462. In this regard, payment provider server 470 includes one or more payment applications 475 which may be configured to interact with user device 410, merchant server 440, and/or merchant location device 462 over network 460 to facilitate the purchase of goods or services by user 405 of user device 410 as discussed above.

Payment provider server 470 also maintains a plurality of user accounts 480, each of which may include account information 485 associated with individual users. For example, account information 485 may include private financial information of users of devices such as account numbers, passwords, device identifiers, user names, phone numbers, credit card information, bank information, or other financial information which may be used to facilitate online transactions by user 405. Account information 485 may also include search parameters for one or more items associated with each user. Advantageously, payment application 475 may be configured to interact with merchant server 440 on behalf of user 405 during a transaction with checkout application 455 and/or merchant location device 462 to track and manage purchases made by users.

A transaction processing application 490, which may be part of payment application 475 or separate, may be configured to receive information from a user device, merchant server 440, and/or merchant location device for processing and storage in a payment database 495 for a context aware shopping service as described above. Transaction processing application 490 may include one or more applications to process information from user 405 and/or the merchant for processing a payment user device 410 as described herein. As such, transaction processing application 490 may store details of a search, an order and associate the details accordingly for individual users. Payment application 475 may be further configured to determine the existence of and to manage accounts for user 405, as well as create new accounts if necessary, such as the set up, management, and use context aware searches as described herein.

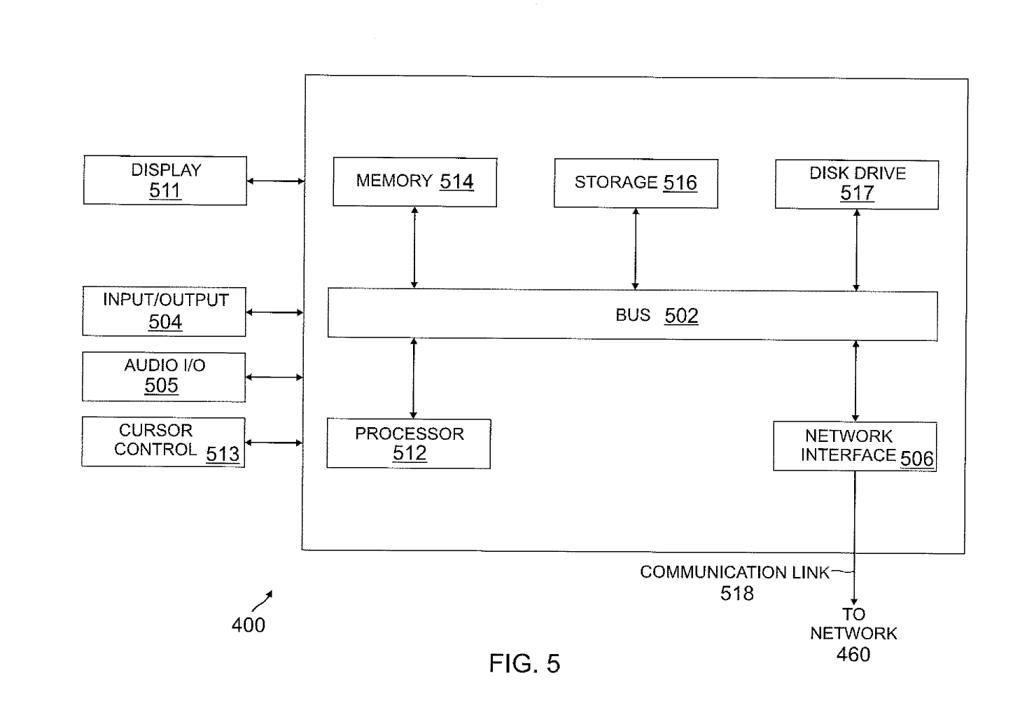

FIG. 5 is a block diagram of a computer system 500 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons or links, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a payment provider server via network 460. In one embodiment, the transmission is wireless, although other transmission mediums and methods may also be suitable. A processor 512, which can be a micro-controller, digital signal processor (DSP), or other processing component, processes these various signals, such as for display on computer system 500 or transmission to other devices via a communication link 518. Processor 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. For example, the description has focused on an offline purchase. However, it may be suitable to use the purchase identifier to pay for an online purchase at a later time. Thus, the present disclosure is limited only by the claims.

What is claimed is:

1. A method comprising:
receiving, by a processor of a service provider, search parameters for an item of interest from a user, wherein the search parameters comprise a location and a distance from the location of the item of interest;
determining, by the processor, whether a merchant offering matches the search parameters; and
transmitting a notification when the search parameters match the merchant offering, wherein the user is notified on a user mobile device.

2. The method of claim 1, wherein the notification is sent by a service provider to the user.

3. The method of claim 1, wherein the user is notified by a merchant.

4. The method of claim 1, wherein the location is a dynamic location of the user mobile device.

5. The method of claim 1, wherein the location is a static location.

6. The method of claim 1, wherein the search parameters comprise a price and a description of the item of interest.

7. The method of claim 1, further comprising processing a payment from the user for purchasing an item in the notification.

8. The method of claim 1, wherein the user is notified by text, email, or voice message.

9. The method of claim 1, wherein a communication is initiated between the user and a merchant when or after the user is notified.

10. The method of claim 1, further comprising presenting the user with a listing of one or more items or services from a merchant when or after the user is notified.

11. The method of claim 1, wherein the determining a match does not require the search parameters to be met exactly by the merchant offering.

12. A non-transitory machine-readable medium comprising a plurality of machine-readable instructions which when executed by one or more processors of a server are adapted to cause the server to perform a method comprising:
receiving search parameters for an item of interest from a user, wherein the search parameters comprise a location and a distance from the location of the item of interest;
determining whether a merchant offering matches the search parameters; and
transmitting a notification when the search parameters match the merchant offering, wherein the user is notified on a user mobile device.

13. The non-transitory machine-readable medium of claim 12, wherein the location is a dynamic location of the user mobile device.

14. The non-transitory machine-readable medium of claim 12, wherein the location is a static location.

15. The non-transitory machine-readable medium of claim 12, wherein the search parameters comprise a price and a description of the item of interest.

16. The non-transitory machine-readable medium of claim 12, wherein the method further comprises processing a payment from the user for purchasing an item in the notification.

17. The non-transitory machine-readable medium of claim 12, wherein the user is notified by text, email, or voice message.

18. The non-transitory machine-readable medium of claim 12, wherein a communication is initiated between the user and a merchant when or after the user is notified.

19. The non-transitory machine-readable medium of claim 12, wherein the method further comprises presenting the user with a listing of one or more items or services from a merchant when or after the user is notified.

20. A system comprising:
means for receiving search parameters for an item of interest from a user, wherein the search parameters comprise a location and a distance from the location of the item of interest;
means for determining whether a merchant offering matches the search parameters; and
means for transmitting a notification when the search parameters match the merchant offering, wherein the user is notified on a user mobile device.
